(19) United States
(12) Patent Application Publication
(10) Pub. No.: US 2003/0141349 A1
(43) Pub. Date: Jul. 31, 2003

(54) SBB HGA rework process

(76) Inventors: Wenzhong Liu, Yichun City (CN); Ping Shang, Dongguan City (CN)

Correspondence Address: KENYON & KENYON (SAN JOSE), 333 WEST SAN CARLOS ST., SUITE 600, SAN JOSE, CA, 95110, US

(21) Appl. No.: 10/302,271

(22) Filed: Nov. 22, 2002

(30) Foreign Application Priority Data
Jan. 26, 2002 (WO) PCT/CN02/00041

(51) Int. Cl. B23K 31/00

(52) U.S. Cl. 228/180.22; 228/191

(57) ABSTRACT

This invention discloses a method for debounding a magnetic head transducer from a head gimbal assembly, said magnetic head transducer being bounded to said head gimbal assembly by a solder ball, which is formed by solder ball bounding process, said method comprising: loading the head gimbal assembly on a fixture; directing a hot air gun to the solder ball of the head gimbal assembly and turning on the hot air gun; and taking away the magnetic head when the solder ball melts.

The slider can be debounded by this method within 3-6s and very easy to design fixture and machine for production.

### BACKGROUND OF THE INVENTION

1. Field of the Invention

This invention relates to head gimbal assemblies in magnetic recording devices, and more particularly to a method for debounding a magnetic head from a SBB type head gimbal assembly.

2. Background Art

In a conventional head gimbal assembly, a magnetic head (the “slider”) is either mechanically attached to a suspension flexure by epoxy bonding, or electrically connected thereto.

FIG. 1(A) is a schematic diagram of a head gimbal assembly (HGA) configuration having an electrical connection. The gimbal assembly is designated generally by the numeral 100, which include a suspension 10, a flexure 20, a FPC 30 (or flex cable) and a slider 40.

FIG. 1(B) is a detailed drawing for slider area of FIG. 1(A) and FIG. 1(C) is a side view of HGA in FIG. 1(B). There are some traces 31 with related bound pads 32 on FPC 30, which are used as signal lines. There also are some bump pads 41 on the slider 40, which are used as slider MR element terminal. In HGA assembly process, it is needed to connect the slider pads 41 to the related trace pads 32, which is usually called slider-bounding process. Now there are two methods to conduct slider-bounding process: GBB (gold ball bound) and SBB (solder ball bound).

In SBB method, a solder ball 42 is put between the pad 41 and the pad 32. Then turn on the laser light, which is focused on the solder ball and cause it to melt so that the two pads were connected by solder after cooled (for details, see U.S. Pat. No. 582831). The bounded HGA is shown in FIG. 1(B) and FIG. 1(C).

For HGA production cost concern, it is needed to study the rework method for slider bounding process to take the slider 40 off from the suspension 10.

### SUMMARY OF THE INVENTION

An object of this invention is to provide a method of debounding slider from the suspension for use with SBB type HGA rework process.

According to one aspect of the invention, a method is provided for debounding a magnetic head transducer from a head gimbal assembly, said magnetic head transducer being bounded to said head gimbal assembly by a solder ball, which is formed by solder ball bounding process, said method comprising: putting the head gimbal assembly on a fixture; directing a hot air gun to the solder ball of the head gimbal assembly and turning on the hot air gun; and taking away the magnetic head when the solder ball melts.

According to a second aspect of the invention, a method is provided for debounding a magnetic head transducer from an electrical conductor, said magnetic head transducer having been bounded in an electrical connection with said electrical conductor by solder ball bounding process, said method comprising directing a hot air gun to the electrical connection of the head gimbal assembly; turning on the hot air gun; and taking away the magnetic head transducer when the connection melts.

According to a third aspect of the invention, a method is provided for debounding a read/write electronic circuitry of a disk drive from an electrical conductor, said read/write electronic circuitry having been bounded in electrical connection with said electrical conductor by solder ball bounding process, said method comprising: directing a hot air gun to a solder connection existing between said read/write electronic circuitry and said conductor; turning on the hot air gun; and taking away the magnetic head transducer when the connection melts.

The slider can be debounded by this method within 3-6s and very easy to design fixture and machine for production.

### BRIEF DESCRIPTION OF THE DRAWING

For a further understanding of the objects, features and advantages of the present invention, reference should be made to the following description of the preferred embodiment, taken in conjunction with the accompanying drawing, in which like parts are given like reference numerals and wherein:

FIG. 1(A) is a schematic diagram of a current head gimbal assembly configuration having an electrical connection;

FIG. 1(B) is a detailed drawing for slider area of FIG. 1(A);

FIG. 1(C) is a side view of HGA in FIG. 1(B);

FIG. 2(A) is a schematic diagram showing that the HGA as shown in FIG. 1(B) is to be debounded with the fixture;

FIG. 2(B) is a schematic diagram showing that the HGA has been debounded with the fixture.

### DETAILED DESCRIPTION OF THE INVENTION

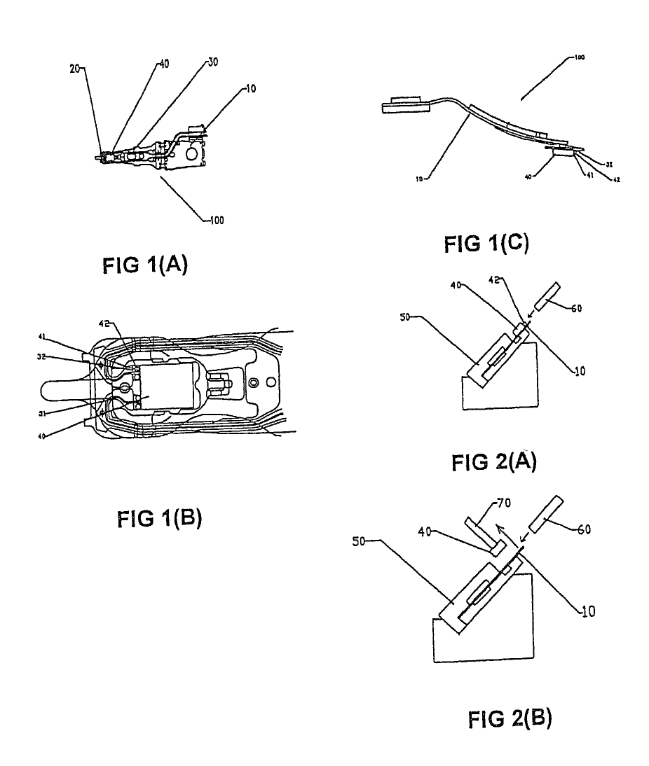

As shown in FIG. 1(B), a head gimbal assembly 100 has a solder ball 42, which achieves an electrical connection between the bump pad 41 and the trace pad 32. The present invention relates to methods for debounding the bump pad 41 from corresponding trace pad 32 so as to detact the slider 40 from the suspension 10.

FIG. 2(A) and (B) are schematic diagrams which illustrate a preferred method for conducting the debounding process. As shown in FIG. 2(A), the structure of the HGA is identical to that shown in FIG. 1(B). The HGA is positioned on a fixture 50 with a slider 40 to be debounded off from the suspension 10. FIG. 2(A) also illustrates a hot air gun 60 aiming at the slider solder ball 42 on the suspension 10. Turn on the hot air gun and select the temperature of the heating process to be within a certain range. The solder ball 42 will melt in a short time.

FIG. 2(B) illustrates, in addition to those as shown in FIG. 2(A), a vacuum tube 70 which is positioned so that the tube 70 is aligned to and is in the proximity of the solder ball 42. When the ball 42 melts while the hot air gun being turned on, the vacuum tube 70 is used to directly take the slider 40 off from the suspension 10.

Heating HGA slider by hot air is controlled by both temperature and time. Since material for the solder ball involved in the inventive methods has a variety of selection and the balls may be of various size, the temperature range of the heating process may vary, and thus the time for melting is different. For solder balls of normal size made from a normal solder material, the preferred temperature of the heating process is within 100-400 centigrade. The preferred work time is 3-8s.

The hot air heating process is just a preferred embodiment according to the invention. Any other heating methods can be used so as to make the solder balls melt in a relative short time.

It should be noted that the heating process described with respect to FIG. 2(A) and (B) could also be used to disconnect other electrical components. For example, the process can be used to disconnect termination pads for the conductors located at the opposite end of the suspension from the slider 82, with the termination pads for the circuitry in the read/write channel.

While the foregoing detailed description has described a method for detaching a termination pad on a magnetic recording head from a conductor, it is to be understood that the above description is illustrative only and should not be considered limiting of the disclosed invention. The invention is to be limited only by the claims as set forth below.

What is claimed is:

1. A method for debounding a magnetic head transducer from a head gimbal assembly, said magnetic head transducer being bounded to said head gimbal assembly by a solder ball, which is formed by solder ball bounding process, said method comprising:
loading the head gimbal assembly on a fixture;
directing a hot air gun to the solder ball of the head gimbal assembly and turn on the hot air gun; and taking away the magnetic head from the suspension when the solder ball melts.

2. The method as set forth in claim 1, wherein the temperature range of hot air output by the hot air gun is controlled to be within 100-400 centigrade and the time for turning on the hot air gun is 3-8s.

3. The method as set forth in claim 1 or 2, wherein said step of taking away is performed by a vacuum tube.

4. A method for debounding a magnetic head transducer from an electrical conductor, said magnetic head transducer having been bounded in an electrical connection with said electrical conductor by solder ball bounding process, said method comprising:
directing a hot air gun to the electrical connection of the head gimbal assembly;
turning on the hot air gun; and
taking away the magnetic head transducer when the connection melts.

5. A method for debounding a read/write electronic circuitry of a disk drive from an electrical conductor, said read/write electronic circuitry having been bounded in electrical connection with said electrical conductor by solder ball bounding process, said method comprising:
directing a hot air gun to a solder connection existing between said read/write electronic circuitry and said conductor;
turning on the hot air gun; and
taking away the magnetic head transducer when the connection melts
